(19) United States
(12) Patent Application Publication
(10) Pub. No.: US 2026/0228758 A1
(43) Pub. Date: Aug. 6, 2026

(54) SYNTHETIC DATA GENERATION AND DISTRIBUTION

(71) Applicant: Walmart Apollo, LLC, Bentonville, AR (US)

(72) Inventors: Dyuti Bhattacharya, Los Altos, CA (US); Eric Robert Anderson, Santa Rosa, CA (US); Matthew William Kennedy, Dublin, CA (US); Sameer Aggarwal, San Ramon, CA (US); Sushanth Kaparthi, Bellevue, WA (US); Zerui Zhang, Milpitas, CA (US); Qianqian Zhang, Castro Valley, CA (US); Ramandeep Singh Narwal, Milpitas, CA (US); Jiachen Liu, Bayonne, NJ (US)

(21) Appl. No.: 19/042,730

(22) Filed: Jan. 31, 2025

(51) Int. Cl. G06Q 30/0201

(52) U.S. Cl. CPC G06Q 30/0201

(57) ABSTRACT

An example method includes obtaining user data from a first platform including item identifiers, first audience data including first audience interactions, and second audience data including second audience interactions. The method includes generating synthetic data for a second platform, distinct from the first platform, based on the first audience data and the second audience data. Generating the synthetic data includes selecting a set of the first audience data and the second audience data and a predetermined number of the item identifiers, and adding the predetermined number of the item identifiers to respective audience interactions of the set of the first audience data and the second audience data to form the synthetic data. The method further includes transmitting the synthetic data to at least one computing device and receiving engagement data responsive to the synthetic data.

### TECHNICAL FIELD

This application relates generally to the generation of synthetic data for causing a change in engagements, and more particularly, using data from a particular platform to generate data for another distinct platform that drives a change in engagements in the other distinct platform.

### BACKGROUND

Systems rely on data to provide accurate and customized experiences to users and/or drive different capabilities. Data used by systems can be limited to single platforms, which limits the amount of data available to systems. Additionally, data from different platforms can be hard to track and raises privacy concerns.

### BRIEF DESCRIPTION OF THE DRAWINGS

Various examples will be described below with reference to the following figures.

FIG. 1 depicts an example system for generating and sharing synthetic data, in accordance with some embodiments.

FIG. 2 depicts a system for generating synthetic data for audience segments, in accordance with some embodiments.

FIGS. 3A and 3B depict a system for generating audience lists for synthetic data generation, in accordance with some embodiments.

FIG. 4 depicts a flow diagram illustrating a method for generating, transmitting, and updating synthetic data, in accordance with some embodiments.

FIG. 5 depicts another flow diagram illustrating a method for generating and distributing synthetic data, in accordance with some embodiments.

FIG. 6 depicts an additional flow diagram illustrating a method for generating and distributing synthetic data, in accordance with some embodiments.

FIG. 7 depicts an example system with a machine-readable medium that includes instructions for generating and distributing synthetic data, in accordance with some embodiments.

FIG. 8 illustrates a block diagram of a computing device, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

The systems and methods disclosed herein may be useful for converting data from one platform (e.g., offline data from brick-and-mortar locations) to another, distinct platform (e.g., online, or digital marketplaces). The conversion of data allows for leveraging data from distinct platforms to achieve different engagement or growth objectives. Additionally, online platforms rely on shared data to enable the use and command of data-driven artificial intelligence (AI) capabilities. However, sharing real data, which is the subject to rapidly evolving regulatory requirements for more consumer privacy, presents additional risks - data privacy, data control, and data tracking. As such, there is a need for systems and methods that are able to convert data from one platform to another platform while protecting or improving data privacy.

The systems and methods disclosed herein provide mechanisms to use data from one platform on other, distinct platforms, while maintaining data privacy. In some embodiments, the systems and methods disclosed herein forgo sharing real data about real omni customer behaviors. In some embodiments, the systems and methods disclosed herein use algorithms to synthesize real streams of customers'offline behavioral data and replace real offline behaviors with artificially generated—or, “synthesized”—digital substitutes. The systems and methods disclosed herein assemble synthesized offline data into digital payloads that are sent to external data-driven platforms (e.g., ad-tech platforms) for subsets of randomized customers. By acting as an integrated offline-to-online data synthesizer and audience control platform, the systems and methods disclosed herein are able to observe differential omni-channel effects on customers'behaviors (e.g., retail behaviors) caused by different data synthesis formulas and thereby establish machine feedback for end-to-end statistical control, and continuous automated optimization of the offline-to-online data synthesizer.

In some embodiments, the systems and methods disclosed herein include a mechanism to synthesize data for real, underlying behaviors, which provides the ability to synthesize data to steer and/or control AI systems and capabilities. In some embodiments, the systems and methods disclosed herein include a mechanism to create different synthetic data from same original data, which provides the ability to synthesize data for different growth objectives. In some embodiments, the systems and methods disclosed herein include a mechanism to measure effects of synthetic data on target system, which provides the ability to measure effects of different synthetic signals by customer segments.

In various embodiments, a system including a processor and a non-transitory memory storing instructions, that when executed, cause the processor to perform one or more operations for generating synthetic data is disclosed. The instructions, when executed, cause the processor to obtain user data from a first platform. The user data includes item identifiers, first audience data including first audience interactions for a first period of time, and second audience data including second audience interactions for a second period of time. The second period of time is before the first period of time. The instructions, when executed, cause the processor to generate synthetic data based on the first audience data and the second audience data. The synthetic data is for a second platform, distinct from the first platform. Generating the synthetic data includes selecting a set of the first audience data and the second audience data, selecting a predetermined number of the item identifiers, and adding the predetermined number of the item identifiers to respective audience interactions of the set of the first audience data and the second audience data to form the synthetic data. The instructions, when executed, cause the processor to transmit the synthetic data to at least one computing device; and receive, from the at least one computing device, engagement data responsive to the synthetic data.

In various embodiments, a computer-implemented method for generating synthetic data is disclosed. The computer-implemented method includes obtaining user data from a first platform. The user data includes item identifiers, first audience data including first audience interactions for a first period of time, and second audience data including second audience interactions for a second period of time. The second period of time is before the first period of time. The computer-implemented method includes generating synthetic data based on the first audience data and the second audience data. The synthetic data is for a second platform, distinct from the first platform. Generating the synthetic data includes selecting a set of the first audience data and the second audience data, selecting a predetermined number of the item identifiers, and adding the predetermined number of the item identifiers to respective audience interactions of the set of the first audience data and the second audience data to form the synthetic data. The computer-implemented method includes transmitting the synthetic data to at least one computing device, and receiving, from the at least one computing device, engagement data responsive to the synthetic data.

In various embodiments, a non-transitory computer readable medium having instructions for generating synthetic data stored thereon is disclosed. The instructions, when executed by at least one processor, cause the at least one device to perform operations including obtaining user data from a first platform. The user data includes item identifiers, first audience data including first audience interactions for a first period of time, and second audience data including second audience interactions for a second period of time. The second period of time is before the first period of time. The instructions, when executed by at least one processor, cause the at least one device to perform operations including generating synthetic data based on the first audience data and the second audience data. The synthetic data is for a second platform, distinct from the first platform. Generating the synthetic data includes selecting a set of the first audience data and the second audience data, selecting a predetermined number of the item identifiers, and adding the predetermined number of the item identifiers to respective audience interactions of the set of the first audience data and the second audience data to form the synthetic data. The instructions, when executed by at least one processor, cause the at least one device to perform operations including transmitting the synthetic data to at least one computing device, and receiving, from the at least one computing device, engagement data responsive to the synthetic data.

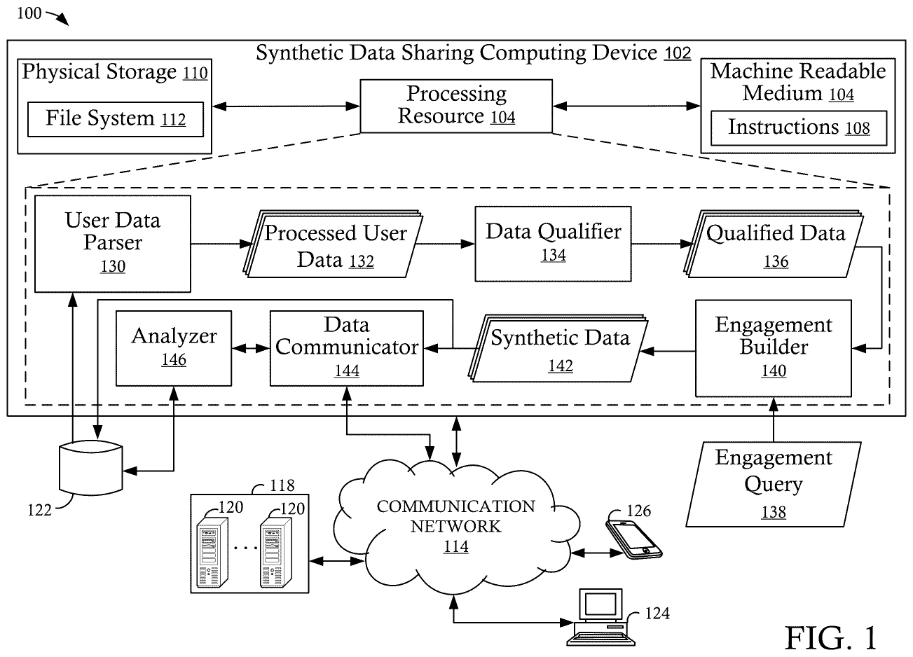

FIG. 1 depicts an example system for generating and sharing synthetic data, in accordance with some embodiments. The system 100 includes a synthetic data sharing computing device 102 that generates synthetic data (e.g., synthetic data 142) that is distributed to at least one computing device. The synthetic data sharing computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The synthetic data sharing computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the synthetic data sharing computing device 102, such as generating synthetic data based on collected or stored user data. The instructions 108 may include instructions for implementing one or more models. In some embodiments, and as will be described further herein below, the synthetic data sharing computing device 102 may execute one or more models, processes, or algorithms, such as a machine learning model, deep learning model, statistical model, etc., (e.g., as implemented as machine readable instructions) to generating synthetic data based on stored user data.

The synthetic data sharing computing device 102 may also include other hardware components, such as physical storage 110. Physical storage 110 may include any physical storage device, such as a hard disk drive, a solid-state drive, or the like, or a plurality of such storage devices (e.g., an array of disks), and may be locally attached (i.e., installed) in the synthetic data sharing computing device 102. In some implementations, physical storage 110 may be accessed as a block storage device.

In some cases, the synthetic data sharing computing device 102 may also include a local file system 112 that may be implemented as a layer on top of the physical storage 110. For example, an operating system may be executing on the synthetic data sharing computing device 102 (by virtue of the processing resource 104 executing certain instructions 108 related to the operating system) and the operating system may provide a file system 112 to store data on the physical storage 110.

The network 114 may include a plurality of devices or systems in communication with the synthetic data sharing computing device 102 over one or more network channels, illustrated as a network cloud. For example, in various embodiments, the synthetic data sharing computing device 102 may be in communication with a web server (not shown), a cloud-based engine 118 including one or more processing devices 120 that may be provisioned for use, a database 122, a workstation 124, and/or any other suitable system or device. The synthetic data sharing computing device 102 may similarly be in communication, either directly or indirectly, with one or more user computing devices 126 operatively coupled over the network 114. The other computing systems may be similar to the synthetic data sharing computing device 102, and may each include at least a processing resource and a machine readable medium.

The synthetic data sharing computing device 102, for example, obtains user data from the database 122 and processes the user data using a user data parser 130. The user data includes item data and contributor data. In some embodiments, the item data includes item identifiers (e.g., unique identifiers for identifying and/or tracking products), item segments (e.g., product groups, product categories and/or product departments), item popularity, item dates (e.g., expiration dates, release date, pre-order dates, etc.), item manufacturer, and/or other item data. In some embodiments, the contributor data includes as contributor name, contributor contact information, contributor identifiers, contributor purchases, contributor demographics, contributor behavioral data, contributor groups, contributor segments (e.g., contributors for a predefined time interval (e.g., 1 week, 2 weeks, 1 month, etc.)), contributor similarities, audience data (e.g., groups or subsets of contributors based on one or more categories, including contributor identification and/or contributor groupings, contributor subsets, etc.), and/or other contributor data. The user data is associated with one or more platforms and/or sources. For example, the user data can be obtained from a first platform, such as physical stores (which include data from in-store purchases and in-store contributors); a second platform, such as online or digital stores (which include data from online purchases and online contributors); and/or an alternate source (e.g., third-party partner that collects data for the user).

The user data parser 130 extracts at least item identifiers and audience data from the user data to form the processed user data 132. The user data parser 130 can extract any number of the item identifies. For example, the processed user data 132 can include at least 10 item identifiers, 1,000 item identifiers, 100,000 item identifiers, etc. In some embodiments, the number of item identifiers extracted by the user data parser 130 is based on a predetermined number of item identifiers selected by the engagement builder 140 (e.g., such that the predetermined number of item identifiers is less than the item identifiers included in the processed user data 132). The user data parser 130 can extract first audience data including first audience interactions for a first period of time, and second audience data including second audience interactions for a second period of time. In some embodiments, the second period of time is before the first period of time. For example, the first audience data can be a first-time audience for the current day (e.g., today's contributors or contributors of the current day (e.g., day 0)) and the second audience data can be an archived audience for a previous day (e.g., contributors from the previous day or days (e.g., day 0-t)). The processed user data 132 is provided to a data qualifier 134.

The data qualifier 134 performs union and de-duplication of, at least, the audience data to generate qualified data 136. The qualified data 136 includes at least the first audience data and the second audience data (after deduplication and union) and the item identifiers. For example, the data qualifier 134 identifies duplicate data in the first audience data and the second audience data, removes duplicate data between the first audience data and the second audience data, and combines the (de-duplicated) first audience data and the second audience data to form the qualified data 136. The qualified data 136 is provided to an engagement builder 140.

The engagement builder 140 generates synthetic data 142 based, in part on, the qualified data 136. In particular, the engagement builder 140 generates synthetic data 142 based on a predetermined number of item identifiers and a set of the first audience data and the second audience data. The engagement builder 140 uses different data synthesis formulas based, in part, on engagement objectives to generate the synthetic data 142, as discussed below. Engagement objectives include one or more of increasing contributor traffic, decreasing contributor traffic, increasing item sales, decreasing item sales, increasing item visibility, decreasing item visibility, increasing item popularity, decreasing item popularity, item obfuscation, item category obfuscation, contributor obfuscation, and/or other growth objectives for achieving a predicted contributor response. In some embodiments, the engagement builder 140 selects the predetermined number of item identifiers and the set of the first audience data and the second audience data based on one or more engagement objectives. In some embodiments, the engagement objective is pre-selected by the synthetic data sharing computing device 102. For example, the synthetic data sharing computing device 102 can automatically select an engagement objective to increase contributor traffic for an item. Alternative, or in addition, in some embodiments, in some embodiments, the engagement objective is defined by an engagement query 138 provided by a user (e.g., via a user input provided through a user interface).

In some embodiments, a user submits an engagement query 138 via a user device (e.g., a web server (e.g., a website hosted by the web server), a cloud-based engine 118, a workstation 124, and/or any other suitable system or device). The use device may send the engagement query 138 to the synthetic data sharing computing device 102 and, in response to receiving the engagement query 138, the synthetic data sharing computing device 102 may execute one or more processes to determine and generate synthetic data 142 and transmit the synthetic data 142 to other computing devices or platforms, as discussed below. In some embodiments, the engagement query 138 is provided via a user interface including one or more user interface elements for selecting one or more engagement objectives, campaign rules, audience segments, and/or other parameters.

The engagement builder 140 uses the engagement query 138 (or the pre-selected engagement objective) to determine one or more parameters for selecting the predetermined number of item identifiers from the item identifiers. As non-limiting examples, the one or more parameters can define a current item category and a target item category, a current item popularity and a target item popularity, a current item visibility and a target item visibility, obfuscation of an item, and/or any other parameters consistent with the engagement objectives. The one or more parameters are used to form a randomized set of item identifiers from the item identifiers that are consistent with the engagement objectives, and remove bias in the randomized set of item identifiers. The engagement builder 140 defines the randomized set of item identifiers as the predetermined number of item identifiers, or selects the predetermined number of item identifiers from the randomized set of item identifiers. In some embodiments, the predetermined number of item identifiers is at least 10, at least 15, at least 20, etc.

The engagement builder 140 selects the set of the first audience data and the second audience data from the qualified data 136. In some embodiments, the engagement builder 140 selects the set of the first audience data and the second audience data based on the one or more parameters. In some embodiments, the engagement builder 140 selects the set of the first audience data and the second audience data from the qualified data 136 based on the one or more parameters determined using the engagement query 138 (or the pre-selected engagement objective). For example, the one or more parameters can be used to select the set of the first audience data and the second audience data from the qualified data 136 such that contributor segments are obfuscated or magnified, contributor behaviors are obfuscated or magnified, contributor engagement is obfuscated or magnified, and/or any other contributor interactions are adjusted in accordance with the engagement query 138 (or the pre-selected engagement objective). In some embodiments, the engagement builder 140 randomly selects the set of the first audience data and the second audience data from the qualified data 136. In some embodiments, the random selection of the set of the first audience data and the second audience data from the qualified data 136 is based, in part, on the one or more parameters.

The engagement builder 140 adds (or appends) the predetermined number of the item identifiers to respective audience interactions of the set of the first audience data and the second audience data to form the synthetic data 142. In this way, the synthetic data 142 simulates audience data and audience interactions to reflect and/or achieve engagement objectives as described above. The engagement builder 140 generates the synthetic data 142 for one or more platforms and/or sources. This allows the engagement builder 140 to control the platforms, sources, and audiences that receive the synthetic data 142. In some embodiments, the synthetic data 142 is associated with platforms and/or sources distinct from the user data and/or audience data. For example, the user data (and extracted audience data) can be from a first platform, such as physical stores, and the generated synthetic data 142 can simulate data for a second platform, such as online or digital stores. In some embodiments, the synthetic data sharing computing device 102 receives only data representing in-person or in-store interactions and generates synthetic data 142 simulating online or digital interactions.

The synthetic data 142 includes control data and treated data (both consistent with the same platform and/or source for the synthetic data 142). The treated data includes simulated audience interactions (e.g., the randomized set of item identifiers or selection thereof) that replace (or append) the respective audience interactions of the set of the first audience data and the second audience data (as described above) and anonymize the first audience data and the second audience data. The control data is untreated or unchanged first audience data and second audience data from the qualified data 136 (e.g., the first audience data and the second audience data not included in the set of the first audience data and the second audience data). By including control data and treated data in the synthetic data 142, the synthetic data sharing computing device 102 allows a user to track and observe the effects of the synthetic data 142 as discussed below.

The synthetic data 142 is provided to a data communicator 144 and an analyzer 146. The data communicator 144 transmits the synthetic data 142 to the at least one computing device, such as a web server (not shown), a cloud-based engine 118, a database 122, a workstation 124, and/or any other suitable system or device. In some embodiments, the data communicator 144 transmits control data of the synthetic data 142 to a first computing device and transmits treated data of the synthetic data 142 to a second computing device, distinct from the first computing device. In other words, the data communicator 144 allows the synthetic data sharing computing device 102 to selectively provide control data or treated data of the synthetic data 142 to different computing devices and/or platforms, as needed. By selectively controlling the recipients of the control data or treated data of the synthetic data 142, the data communicator 144 allows the synthetic data sharing computing device 102 to steer or control computing devices (and/or their associated platforms). Further, the data communicator 144 receives, from the at least one computing device, engagement data responsive to the synthetic data 142. The data communicator 144 provides the received engagement data to the analyzer 146 for analysis, which can use the engagement data to measure effects of the synthetic data 142 by computing device and/or platform, as discussed below.

The analyzer 146 stores received the synthetic data 142 and received engagement data in database 122. The analyzer 146 can analyze the synthetic data 142 and/or received engagement data to observe differential omni-channel effects on audience behavior (a user's audience or partner audiences) caused by the synthetic data 142. For example, the analyzer 146 can use the control data and treated data in the synthetic data 142 to track audience behaviors and changes in engagement objectives, as well as the effects of the synthetic data 142 on different computing devices and/or platforms. The analyzer 146 uses observed differential omni-channel effects on audience behavior caused by the synthetic data 142 to establish machine feedback for end-to-end statistical control, and continuous automated optimization of the offline-to-online data synthesizer (e.g., generation of platform and/or specific synthetic data 142 as discussed above with reference to the engagement builder 140).

The analyzer 146 can determine, based on the engagement data, a change in engagements in response to the synthetic data 142. The analyzer 146, in accordance with a determination that the change in the engagements in response to the synthetic data does not satisfy an engagement change threshold, adjusts selection of the predetermined number of the item identifiers. For example, the analyzer 146 can provide feedback to the engagement builder 140 to update and/or generate new synthetic data 142. In some embodiments, the feedback to the engagement builder 140 causes the engagement builder 140 to select a new or an updated predetermined number of the item identifiers based on the feedback. Alternatively, or in addition, in some embodiments, the feedback to the engagement builder 140 causes the engagement builder 140 to generate an updated or a new randomized set of item identifiers based on the feedback.

In some embodiments, training data is generated for one or more models (e.g., machine learning models, deep learning models, statistical models, algorithms, etc.) based on user data, synthetic data 142, the engagement query 138, feedback from the analyzer 146, etc. One or more models are trained based on corresponding training data. The trained models may be stored in a database, such as in the database 122 (e.g., a cloud storage database).

The models, when executed by the synthetic data sharing computing device 102, allow the synthetic data sharing computing device 102 to generate synthetic data 142 or update synthetic data 142. For example, the synthetic data sharing computing device 102 may obtain one or more models from the database 122. The synthetic data sharing computing device 102 may then receive, in real-time, an engagement query 138 and/or feedback from the analyzer 146. In response to receiving the engagement query 138 and/or feedback from the analyzer 146, the synthetic data sharing computing device 102 may execute one or more models to generate synthetic data 142 or update synthetic data.

In some embodiments, the synthetic data sharing computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, synthetic data sharing computing device 102 may generate synthetic data 142 or update synthetic data 142.

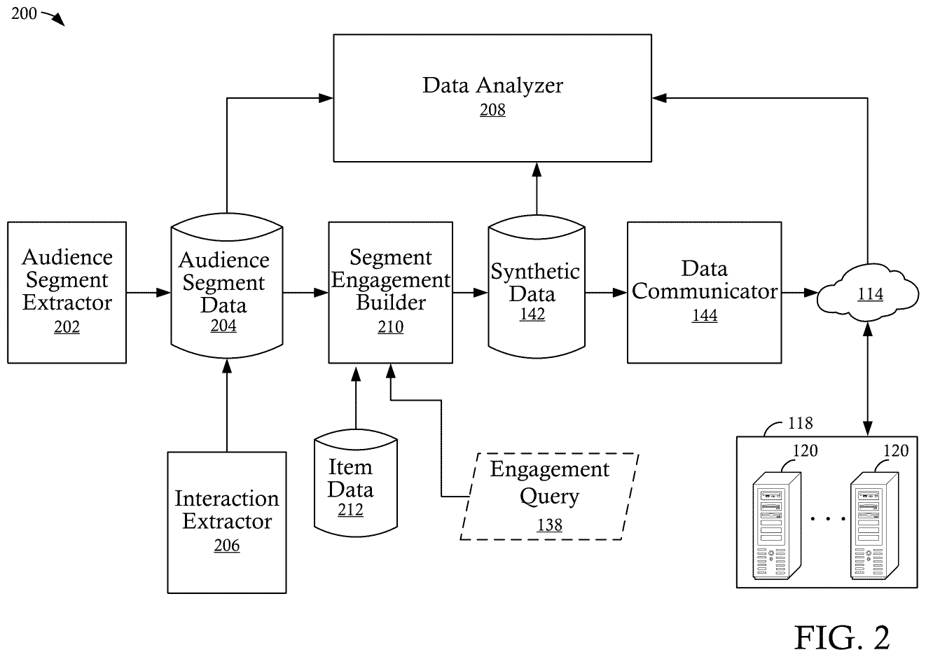

FIG. 2 depicts a system for generating synthetic data for audience segments, in accordance with some embodiments. The system 200 for generating synthetic data for audience segments includes an audience segment extractor 202, audience segment data 204, an interaction extractor 206, a segment engagement builder 210, item data 212, synthetic data 142, data communicator 144, data analyzer 208, network 114, and a cloud-based engine 118 (and/or any other suitable system or device described above in reference to FIG. 1).

The audience segment extractor 202 extracts audience data for one or more segments from user data (e.g., user data from database 122; FIG. 1). The audience segment extractor 202, like the user data parser 130 (FIG. 1), extracts audience data from user data and further parses the audience data into one or more audience segments (e.g., audience for one or more predetermined grouping (e.g., item categories, contributor groupings, contributor segments, etc.)). Similar to the user data parser 130, the audience segment extractor 202 extracts first audience data and second audience data. The audience segment extractor 202 stores the first audience data and second audience data in the audience segment data 204. In some embodiments, the system 200 performs union and deduplication of the first audience data and second audience data (forming qualified audience data) before storing the first audience data and second audience data in the audience segment data 204.

The interaction extractor 206 extracts interactions of the contributors from the first audience data and second audience data. In particular, the interaction extractor 206 parses interactions of the contributors from the first audience data and second audience data and stores the interactions the audience segment data 204. The respective interactions of the contributors from the first audience data and second audience data are associated with the first audience data and second audience data (or qualified audience data).

The segment engagement builder 210 (analogous to engagement builder 140; FIG. 1) generates synthetic data 142 based on the first audience data and second audience data (or qualified audience data), the respective interactions of the contributors from the first audience data and second audience data (or qualified audience data), and item data 212. In particular, the segment engagement builder 210 uses different data synthesis formulas based, in part, on engagement objectives to generate the synthetic data 142. In some embodiments, the different data synthesis formulas and/or the engagement objectives are selected based on an engagement query 138 provided by a user. The item data 212 includes information on items for the user including the items associated with the respective interactions of the contributors. For example, the item data 212 can include an item price, an item category, an item identifier, and/or other item level attribute.

The segment engagement builder 210 selects a randomized set of item identifiers and appends a predetermined number of item identifiers from the randomized set of item identifiers to a set of the respective interactions of the contributors from the first audience data and second audience data (or qualified audience data) and a set of the first audience data and second audience data. In some embodiments, the set of the respective interactions of the contributors from the first audience data and second audience data (or qualified audience data) and the set of the first audience data and second audience data are less than the total respective interactions of the contributors from the first audience data and second audience data (or qualified audience data) and the first audience data and second audience data (e.g., resulting in control data and treated data). Alternatively, in some embodiments, the set of the respective interactions of the contributors from the first audience data and second audience data (or qualified audience data) and the set of the first audience data and second audience data are equal to the total respective interactions of the contributors from the first audience data and second audience data (or qualified audience data) and the first audience data and second audience data (e.g., resulting fully treated data).

As described above in reference to FIG. 1, the randomized set of item identifiers is based in part on engagement objectives and/or the engagement query 138. By appending the predetermined number of item identifiers from the randomized set of item identifiers to the respective interactions of the contributors from the first audience data and second audience data (or qualified audience data), the segment engagement builder 210 anonymizes audience behavior (e.g., contributor purchase behaviors, category interest, purchase patterns, etc.) and causes a change in engagements in response to the synthetic data 142. The segment engagement builder 210 further stores the synthetic data 142.

The system 200 transmits the synthetic data 142 using the data communicator 144 via network 114 and an analyzer 146. The data communicator 144 transmits the synthetic data 142 to the at least one computing device, such as a web server (not shown), the cloud-based engine 118, a database 122, a workstation 124, and/or any other suitable system or device.

The data analyzer 208 receives the audience segment data 204, the synthetic data 142, and/or any engagement data responsive to the synthetic data 142 provided by the at least one computing device. Similar to the analyzer 146 (FIG. 1), the data analyzer 208 observes differential omni-channel effects on audience behavior caused by the synthetic data 142. The data analyzer 208 can establish machine feedback for end-to-end statistical control, and continuous automated optimization of the offline-to-online data synthesizer. The data analyzer 208 can also measure a change in engagements in response to the synthetic data 142. The data analyzer 208 can determine whether the change in engagements in response to the synthetic data 142 satisfies an engagement change threshold. Depending on whether the engagement change threshold is satisfied or not, the data analyzer 208 can adjust the synthetic data 142. For example, if the engagement change threshold is not satisfied, the data analyzer 208 can cause the segment engagement builder 210 to adjust the randomized set of item identifiers, the predetermined number of item identifiers from the randomized set of item identifiers, the size of the set of the respective interactions of the contributors from the first audience data and second audience data (or qualified audience data), the size of the set of the first audience data and second audience data, and/or other factors.

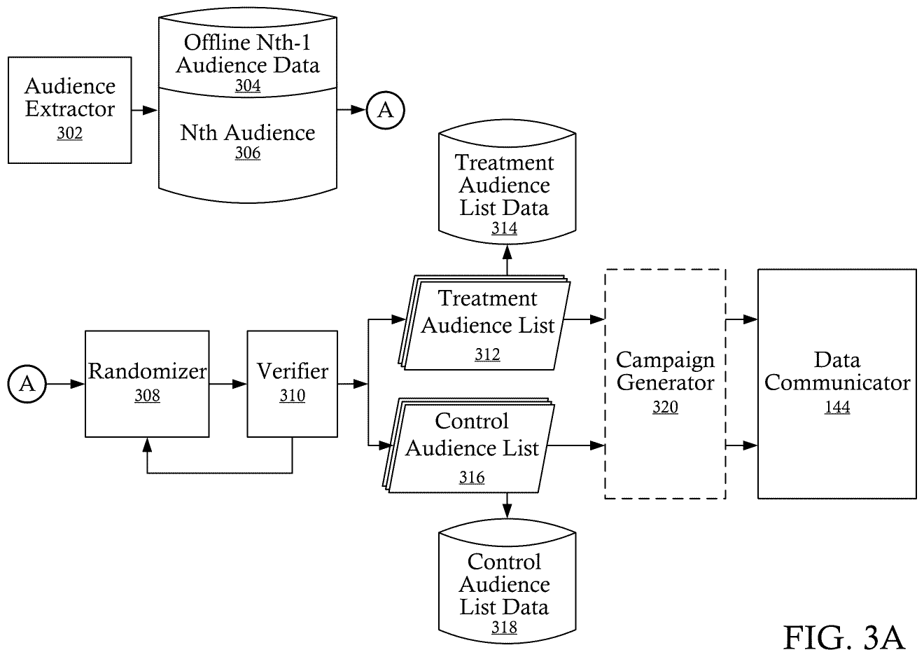

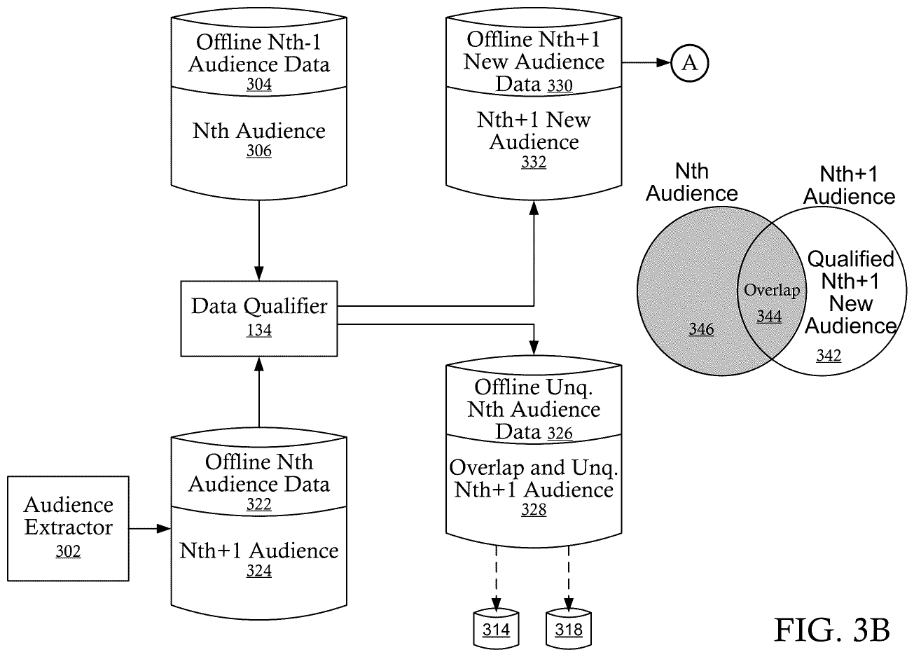

FIGS. 3A and 3B depict a system for generating audience lists for synthetic data generation, in accordance with some embodiments. In particular, the system 300 shows the generation of audiences for different days. FIG. 3A shows the generation of audience lists for a first day or at the initiation of the system 300 and FIG. 3B shows the generation of audience lists for subsequent days. FIGS. 3A and 3B include an audience extractor 302, offline audience data (e.g., offline Nth−1 audience data 304, offline Nth audience data 322, offline Nth+1 new audience data 330, and offline unqualified Nth audience data 326), audience data (e.g., Nth audience 306, Nth+1 audience 324, Nth+1 new audience 332, overlap and unqualified Nth+1 audience 328), a data qualifier 134, a randomizer 308, a verifier 310, treatment audience list data 314, treatment audience list 312, control audience list 316, control audience list data 318, a campaign generator 320, and a data communicator 144.

The audience extractor 302 extracts audience data from user data similar to the user data parser 130 (FIG. 1) and/or the audience segment extractor 202 (FIG. 2). The user data includes item data and contributor data as described above in reference to FIG. 1. On the first day (day 0; e.g., the first iteration of a process performed by the system 300), the audience extractor 302 extracts and stores Nth audience 306 and offline Nth−1 audience data 304, where N=0. The Nth audience 306 includes audience data and the offline Nth−1 audience data 304 includes offline audience interactions described above. If the user data includes item data and contributor data for days before the first day the system 300 is initiated, the Nth audience 306 can include a first audience data for the current day and/or second audience data for the previous day(s) and the offline Nth−1 audience data 304 can include current day offline audience interactions corresponding to the first audience data and/or previous day(s) offline audience interactions corresponding to the second audience data. Alternatively, if the user data does not include audience interactions for days before the first day the system 300 is initiated, the Nth audience 306 can include audience data for the current day and the offline Nth−1 audience data 304 can include offline audience interactions corresponding to the audience data for the current day. The Nth audience 306 and offline Nth−1 audience data 304 are provided to a randomizer 308.

The randomizer 308 and verifier 310 perform operations of the engagement builder 140 (FIGS. 1 and 2). In some embodiments, the randomizer 308 and verifier 310 are part of or are included in the engagement builder 140. For example, the randomizer 308 forms a randomized set of item identifiers from the item identifiers based on engagement objectives, selects a predetermined number of item identifiers from the randomized set of item identifiers, selects a set of the audience data from the Nth audience 306, and appends the predetermined number of item identifiers from the randomized set of item identifiers to a set audience interactions from the offline Nth−1 audience data 304 corresponding to the set of the audience data from the Nth audience 306.

The verifier 310 is configured to detect bias in an output of the randomizer 308. If the verifier 310 determines that the output of the randomizer 308 has bias, the verifier 310 returns the output to the randomizer 308. The randomizer 308 iteratively performs its operations until the verifier 310 ceases to detect bias in the output of the randomizer 308. The verifier 310, after determining that the output of the randomizer 308 does not have bias, outputs synthetic data (e.g., synthetic data 142; FIGS. 1 and 2).

As described above in reference to FIG. 1, the synthetic data can include control data and treated data. The treated data includes the set of the audience data from the Nth audience 306 with the appended predetermined number of item identifiers from the randomized set of item identifiers and the control data includes Nth audience 306 not included in the set of the audience data from the Nth audience 306 and corresponding audience interactions from the offline Nth−1 audience data 304. The audience list for the treated data, treatment audience list 312, and the audience list for the control data, control audience list 316, are separately tracked and stored in respective databases (e.g., treatment audience list data 314 and control audience list data 318). As described above, the synthetic data is synthesized data for a separate platform. For example, the offline audience data (e.g., in-store purchases) can be appended with predetermined number of item identifiers from the randomized set of item identifiers to simulate online audience data (e.g., online or digital purchases). Similarly, the synthetic data is synthesized data that can conceal or simulate contributor behavior, contributor interactions, and/or other contributor data based on engagement objectives.

The treatment audience list 312 and the control audience list 316 from the synthetic data are provided to the campaign generator 320 and/or a data communicator 144. The campaign generator 320 prepares the treatment audience list 312 and the control audience list 316 for distribution to one or more computing devices by forming one or more tables for tracking the distribution of the treatment audience list 312 and the control audience list 316 to one or more computing devices. For example, a table formed by the campaign generator 320 can indicate that a first set of the treatment audience list 312 was distributed to a first computing device (or first partner), the first set and a second set of the treatment audience list 312 was distributed to a second computing device (or second partner), a first set of the control audience list 316 was distributed to a third computing device (or third partner). In seme embodiments, the campaign generator 320 generates one or more rules for a campaign based on the treatment audience list 312 and/or the control audience list 316. For example, the campaign generator 320 can select rules for defining a duration of a campaign (e.g., 1 week, 2 weeks, 1 month, etc.), a campaign frequency (e.g., 2hours a day, 3 days a week, every morning at 9:00 AM, etc.), a campaign type (e.g., banners, videos, popups, audio, etc.), a campaign category, a campaign audience, etc. In some embodiments, the one or more rules for a campaign are based on engagement objectives and/or the one or more parameters for generating the synthetic data.

The data communicator 144 receives the synthetic data (e.g., the treatment audience list 312 and the control audience list 316) and, if applicable, campaign data (e.g., campaign tables and/or campaign rules) from the campaign generator 320 and distributes the synthetic data to one or more computing devices (based on the campaign data and/or engagement objectives). As described above in reference to FIGS. 1 and 2, the data communicator 144 receives engagement data responsive to the synthetic data from the one or more computing devices. The engagement data can be used to update the synthetic data or form new synthetic data as described above in reference to FIGS. 1 and 2.

Turning to FIG. 3B, the system 300 generates audience lists for the day following the first day (e.g., where the second day is N+1 and the first day is N; where N=0). The audience extractor 302 extracts audience data from the user data for the day after the first day. For example, the audience extractor 302 extracts and stores at least the Nth+1 audience 324 and the offline Nth audience data 322. The Nth+1 audience 324 includes audience data for the current day (e.g., Nth+1) and the offline Nth audience data 322 includes offline audience interactions for the previous day (e.g., the first day or N). The Nth+1 audience 324 and the offline Nth audience data 322 are provided to the data qualifier 134.

The data qualifier 134 receives the Nth audience 306, the offline Nth−1 audience data 304, the Nth+1 audience 324, and the offline Nth audience data 322. The Nth audience 306 and the offline Nth−1 audience data 304 are data extracted by the audience extractor 302 during the previous day's iteration the system 300 processes. As described above in reference to FIG. 1, the data qualifier 134 performs union and de-duplication of received data, such as the Nth audience 306, the offline Nth−1 audience data 304, the Nth+1 audience 324, and the offline Nth audience data 322. The data qualifier 134 identifies qualified and unqualified data from the received data and stores the qualified and unqualified data in respective databases. For example, the data qualifier 134 identifies unqualified data from the Nth audience 306, the offline Nth−1 audience data 304, the Nth+1 audience 324, and the offline Nth audience data 322, and stores the unqualified data in the offline unqualified Nth audience data 326 and the unqualified Nth+1 audience 328 databases. Similarly, the data qualifier 134 identifies qualified data from the Nth audience 306, the offline Nth−1 audience data 304, the Nth+1 audience 324, and the offline Nth audience data 322, and stores the qualified data in the offline Nth+1 new audience data 330 and the Nth+1 new audience 332 databases.

Qualified data includes audience and offline audience data that is not repeated between the Nth audience 306, the Nth+1 audience 324, and their respective offline audience data and/or data included in only the Nth+1 audience (and its corresponding offline Nth audience data). For example, qualified data would include the qualified Nth+1 new audience 342 of the Venn diagram shown in FIG. 3B and its corresponding offline Nth audience data. Alternatively, unqualified data includes audience and offline audience data that is repeated between the Nth audience and the Nth+1 audience, and their respective offline new audience data; as well as data included only in the Nth audience (and its corresponding offline Nth−1 audience data). For example, unqualified data may include, at least, the overlap 344 and unqualified Nth+1 audience 346 of the Ven diagram shown in FIG. 3B (e.g., shaded regions of the Ven diagram) and their corresponding offline audience data.

In some embodiments, the unqualified data (e.g., the offline unqualified Nth audience data 326 and the unqualified Nth+1 audience 328) are stored in treatment audience list data 314 and control audience list data 318. In other words, the treatment audience list data 314 and control audience list data 318 determined by the system 300 for the previous day remain stored in their original condition.

The offline Nth+1 new audience data 330 and the Nth+1 new audience 332 are provided to the randomizer 308 and the verifier 310. The randomizer 308 and the verifier 310 determine a treatment audience list 312 and a control audience list 316 for the current day (N+1) and store the treatment audience list 312 and the control audience list 316 for the current day in the treatment audience list data 314 and control audience list data 318, respectively. Additionally, the treatment audience list 312 and the control audience list 316 for the current day are provided to the campaign generator 320 and/or the data communicator 144 for distribution of the synthetic data to one or more computing devices.

It will be understood that, although the terms “first,” “second,” etc. may be used herein to describe various elements, these elements should not be limited by these terms. These terms are only used to distinguish one element from another. Similarly, first day, previous day, current day, etc. are terms only used to distinguish the different elements of the system 300. It will be understood that the processes of the system 300 can be performed for any subsequent days. For example, the system 300 generating audience lists for the fifth day would utilize the process outlined in FIG. 3B where N=4 and N+1=5.

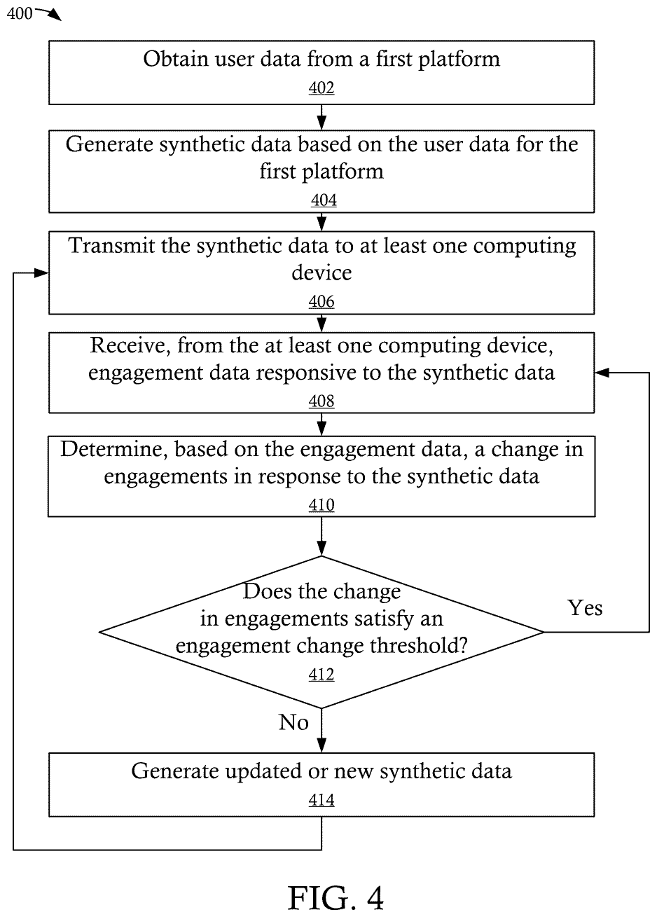

FIGS. 4-7 depict example methods for generating and transmitting synthetic data, in accordance with some embodiments. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The methods shown in FIGS. 4-7 may be implemented in the form of executable instructions stored on machine-readable media and executed by a processing resource and/or in the form of electronic circuitry. For example, aspects of the methods may be described below as being performed by a synthetic data sharing computing device 102 or parts thereof, an example of which may be an engagement builder 140 running on a hardware processing resource 104 of the synthetic data sharing computing device 102 described above in reference to FIG. 1. Additionally, other aspects of the methods described below may be described with reference to other elements shown in FIGS. 1-3B for non-limiting illustration purposes.

FIG. 4 depicts a flow diagram illustrating a method for generating, transmitting, and updating synthetic data, in accordance with some embodiments. The method is performed by a computing device, such as synthetic data sharing computing device 102 (FIG. 1) and/or computing devices communicatively coupled with the synthetic data sharing computing device 102, such as a cloud-based engine 118 including one or more processing devices 120 that may be provisioned for use, a database 122, a workstation 124, and/or any other suitable system or device.

The method 400 includes obtaining (402) user data from a first platform. As described above in reference to FIG. 1, the first platform can be a physical store. The method 400 includes generating (404) synthetic data based on the user data for the first platform and transmitting (406) the synthetic data to at least one computing device. As noted above in FIGS. 1 and 2, the synthetic data is for a second platform distinct from the first platform. For example, the synthetic data can be for online or digital stores.

The method 400 further includes receiving (408), from the at least one computing device, engagement data responsive to the synthetic data and determining (410), based on the engagement data, a change in engagements in response to the synthetic data. In accordance with a determination that the change in engagements satisfies an engagement change threshold (“YES” at operation 412), the method 400 returns to operation 408 and continues to monitor received engagement data responsive to the synthetic data. Alternatively, in accordance with a determination that the change in engagements does not satisfy the engagement change threshold (“NO” at operation 412), the method 400 includes generating (414) updated or new synthetic data. As described above in reference to FIGS. 1 and 2, the synthetic data can be updated, or new synthetic data can be generated through selection of a new or an updated predetermined number of the item identifiers and/or generation of an updated or a new randomized set of item identifiers.

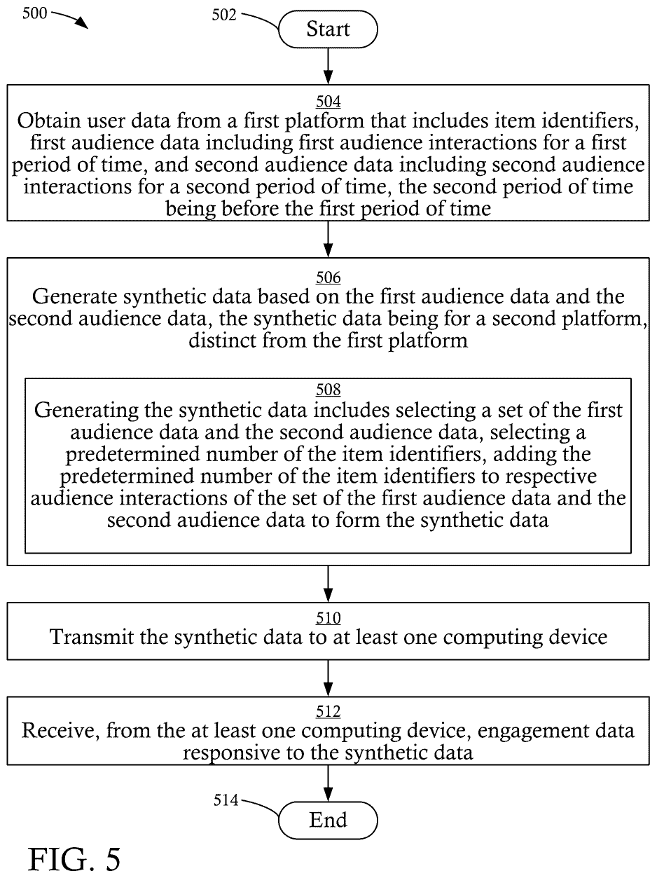

FIG. 5 depicts another flow diagram illustrating a method for generating and distributing synthetic data, in accordance with some embodiments. The method 500 starts at (502) and continues to operation (504), which includes obtaining user data from a first platform. The user data includes item identifiers, first audience data including first audience interactions for a first period of time, and second audience data including second audience interactions for a second period of time, the second period of time being before the first period of time.

The method 500 continues to operation (506) which includes generating synthetic data based on the first audience data and the second audience data. The synthetic data is for a second platform, distinct from the first platform. Generating the synthetic data includes, as described by operation (508) of method 500, selecting a set of the first audience data and the second audience data, selecting a predetermined number of the item identifiers, and adding the predetermined number of the item identifiers to respective audience interactions of the set of the first audience data and the second audience data to form the synthetic data.

The method 500 proceeds to operation (510), which include transmitting the synthetic data to at least one computing device. The method 500 then proceeds to operation (512). Operation (512) includes receiving, from the at least one computing device, engagement data responsive to the synthetic data. The method 500 ends at (514).

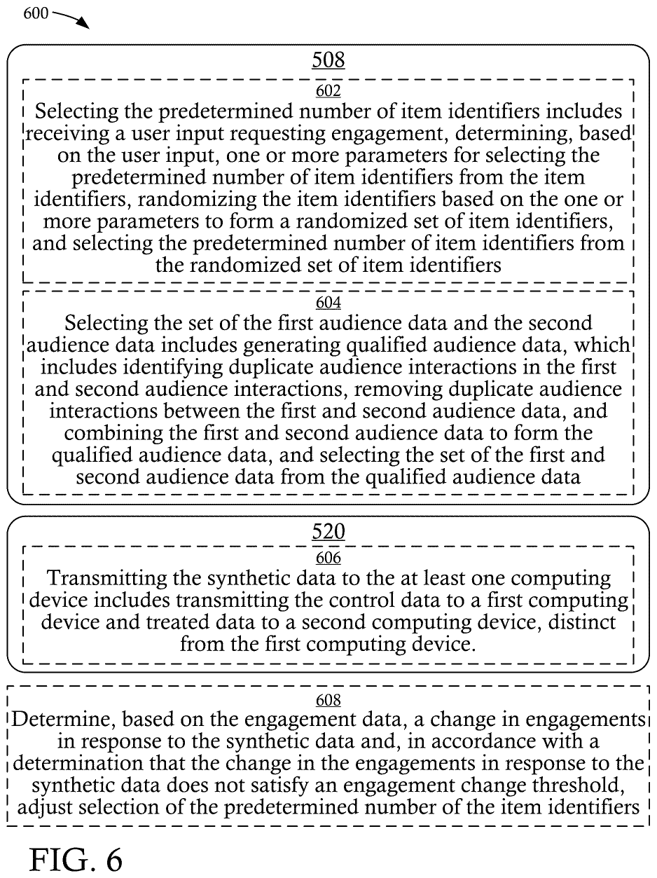

FIG. 6 depicts an example method expanding on the method for generating and distributing synthetic data, in accordance with some embodiments. The method 600 includes one or more operations that run in conjunction with, before, and/or after one or more operations of method 500. As indicated above, in some embodiments, one or more blocks of the methods may be executed substantially concurrently and/or in a different order than shown. In some embodiments, the method 600 includes operations performed with operation (508) of FIG. 5. For example, the method 600 can include operation 602, which expands on operation (508) by providing that selecting the predetermined number of item identifiers includes receiving a user input requesting engagement, determining, based on the user input, one or more parameters for selecting the predetermined number of item identifiers from the item identifiers, randomizing the item identifiers based on the one or more parameters to form a randomized set of item identifiers, and selecting the predetermined number of item identifiers from the randomized set of item identifiers. In some embodiments, the method 600 further includes operation 608 that expands on operation (508) by providing that selecting the set of the first audience data and the second audience data includes generating qualified audience data and selecting the set of the first audience data and the second audience data from the qualified audience data. Generating the qualified audience data includes identifying duplicate audience interactions in the first audience interactions and the second audience interactions, removing duplicate audience interactions between the first audience data and the second audience data, and combining the first audience data and the second audience data to form the qualified audience data.

In some embodiments, the first platform is an in-store platform, and the second platform is an online platform. In some embodiments, the synthetic data includes control data and treated data. In some embodiments, the treated data includes simulated audience interactions that i) replace the respective audience interactions of the set of the first audience data and the second audience data and ii) anonymize the first audience data and the second audience data.

In some embodiments, the method 600 includes operation (606) that expands on operation (520) of FIG. 5 by providing transmitting the synthetic data to the at least one computing device includes transmitting the control data to a first computing device and transmitting the treated data to a second computing device, distinct from the first computing device.

In some embodiments, the method 600 includes operations (607), which includes determining, based on the engagement data, a change in engagements in response to the synthetic data and, in accordance with a determination that the change in the engagements in response to the synthetic data does not satisfy an engagement change threshold, adjusting selection of the predetermined number of the item identifiers.

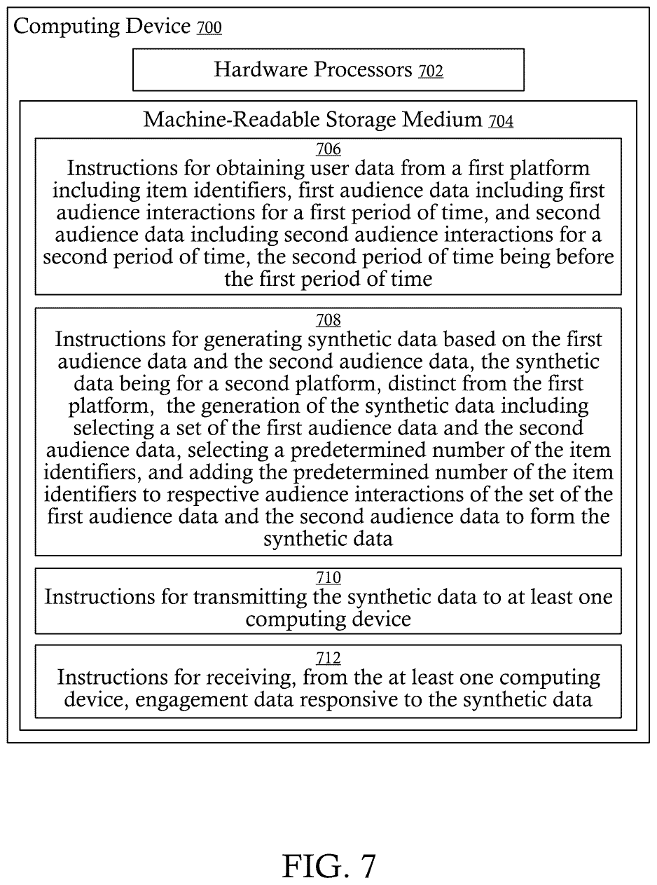

FIG. 7 depicts an example system with a machine-readable medium that includes instructions for generating and distributing synthetic data, in accordance with some embodiments. FIG. 7 depicts an example system 700 that includes non-transitory, machine-readable media 704 encoded with example instructions executable by processing resource 702. In some implementations, the system 700 may be useful for implementing aspects of the synthetic data generation process of at least FIG. 1. For example, the instructions encoded on machine-readable media 704 may be included in instructions 108 of FIG. 1. In some implementations, functionality described with respect to FIG. 1 may be included in the instructions encoded on machine-readable media 704.

The processing resource 702 may include a microcontroller, a microprocessor, central processing unit core(s), an ASIC, an FPGA, and/or other hardware device suitable for retrieval and/or execution of instructions from the machine-readable media 704 to perform functions related to various examples. Additionally, or alternatively, the processing resource 702 may include or be coupled to electronic circuitry or dedicated logic for performing some or all of the functionality of the instructions described herein.

The machine-readable media 704 may be any medium suitable for storing executable instructions, such as RAM, ROM, EEPROM, flash memory, a hard disk drive, an optical disc, or the like. In some example implementations, the machine-readable media 704 may be a tangible, non-transitory medium. The machine-readable media 704 may be disposed within the system 700 respectively, in which case the executable instructions may be deemed installed or embedded on the system. Alternatively, the machine-readable media 704 may be a portable (e.g., external) storage medium, and may be part of an installation package.

As described further herein below, the machine-readable media 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 7.

With reference to FIG. 7, the machine-readable media 704 includes instructions 706-712. Instructions 706, when executed, cause the processing resource 702 obtain user data from a first platform. The user data includes item identifiers, first audience data including first audience interactions for a first period of time, and second audience data including second audience interactions for a second period of time, the second period of time being before the first period of time. Instructions 708, when executed, cause the processing resource 702 to generate synthetic data based on the first audience data and the second audience data, the synthetic data being for a second platform, distinct from the first platform. Generation of the synthetic data includes selecting a set of the first audience data and the second audience data, selecting a predetermined number of the item identifiers, and adding the predetermined number of the item identifiers to respective audience interactions of the set of the first audience data and the second audience data to form the synthetic data,

Instructions 710, when executed, cause the processing resource 702 to transmit the synthetic data to at least one computing device. Instructions 712, when executed, cause the processing resource 702 to receive, from the at least one computing device, engagement data responsive to the synthetic data.

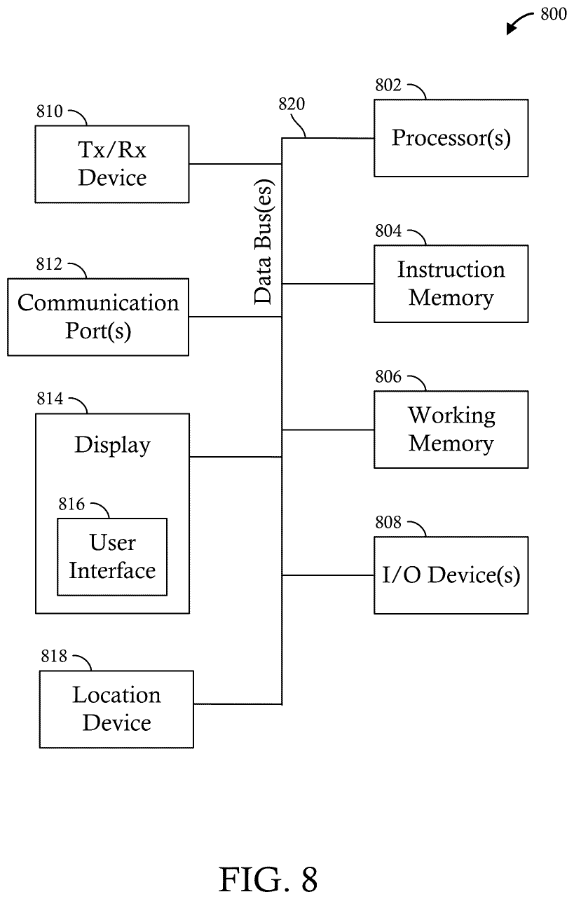

FIG. 8 illustrates a block diagram of a computing device, in accordance with some embodiments. Although FIG. 8 is described with respect to certain components shown therein, it will be appreciated that the elements of the computing device may be combined, omitted, and/or replicated. In addition, it will be appreciated that additional elements other than those illustrated in FIG. 8 may be added to the computing device.

As shown in FIG. 8, the computing device 800 may include one or more processing resources 802, instruction memory 804, working memory 806, input/output devices 808, transceiver 810, communication ports 812, display 814, optional location device 818, and/or any other suitable elements each operatively coupled to one or more data buses 820. The data buses 820 allow for communication among the various components. The data buses 820 may include wired, or wireless, communication channels.

The one or more processing resources 802 may include any processing circuitry operable to control operations of the computing device 800. In some embodiments, the one or more processing resources 802 include one or more distinct processors, each having one or more cores (e.g., processing circuits). Each of the distinct processors may have the same or different structure. The one or more processing resources 802 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 802 may also be implemented by a controller, a microcontroller, an application specific integrated circuit (ASIC), a field programmable gate array (FPGA), a programmable logic device (PLD), etc.

In some embodiments, the one or more processing resources 802 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 804 may store instructions that are accessed (e.g., read) and executed by at least one of the one or more processing resources 802. For example, the instruction memory 804 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 802 may perform a certain function or operation by executing code, stored on the instruction memory 804, embodying the function or operation. For example, the one or more processing resources 802 may execute code stored in the instruction memory 804 to perform one or more of any function, method, or operation disclosed herein.

Additionally, the one or more processing resources 802 may store data to, and read data from, the working memory 806. For example, the one or more processing resources 802 may store a working set of instructions to the working memory 806, such as instructions loaded from the instruction memory 804. The one or more processing resources 802 may also use the working memory 806 to store dynamic data created during one or more operations. The working memory 806 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 804 and working memory 806, it will be appreciated that the computing device 800 may include a single memory unit that operates as both instruction memory and working memory. Further, although embodiments are discussed herein including non-volatile memory, it will be appreciated that computing device 800 may include volatile memory components in addition to at least one non-volatile memory component.

In some embodiments, the instruction memory 804 and/or the working memory 806 includes an instruction set, in the form of a file for executing various methods, such as methods for generating synthetic data, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 802.

The input/output devices 808 may include any suitable device that allows for data input or output. For example, the input/output devices 808 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 810 and/or the communication port(s) 812 allow for communication with a network. For example, if a communication network is a cellular network, the transceiver 810 allows communications with the cellular network. In some embodiments, the transceiver 810 is selected based on the type of the communication network the computing device 800 will be operating in. The one or more processing resources 802 are operable to receive data from, or send data to, a network, via the transceiver 810.

The communication port(s) 812 may include any suitable hardware, software, and/or combination of hardware and software that is capable of coupling the computing device 800 to one or more networks and/or additional devices. The communication port(s) 812 may be arranged to operate with any suitable technique for controlling information signals using a desired set of communications protocols, services, or operating procedures. The communication port(s) 812 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 812 allows for the programming of executable instructions in the instruction memory 804. In some embodiments, the communication port(s) 812 allow for the transfer (e.g., uploading or downloading) of data, such as machine learning model training data.

In some embodiments, the communication port(s) 812 couples the computing device 800 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 810 and/or the communication port(s) 812 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), Zigbee, Etc.

The display 814 may be any suitable display, and may display the user interface 816. The user interfaces 816 may enable user interaction with the synthetic data sharing computing device 102. For example, the user interface 816 may be a user interface for an application of a network environment operator that allows a user to view and interact with the operator's website. In some embodiments, a user may interact with the user interface 816 by engaging the input/output devices. In some embodiments, the display 814 may be a touchscreen, where the user interface is displayed on the touchscreen.

The display 814 may include a screen such as, for example, a Liquid Crystal Display (LCD) screen, a light-emitting diode (LED) screen, an organic LED (OLED) screen, a movable display, a projection, etc. In some embodiments, the display 814 may include a coder/decoder, also known as Codecs, to convert digital media data into analog signals. For example, the visual peripheral output device may include video Codecs, audio Codecs, or any other suitable type of Codec.

The optional location device 818 may be communicatively coupled to a location network and operable to receive position data from the location network. For example, in some embodiments, the location device 818 includes a GPS device that receives position data identifying a latitude and longitude from one or more satellites of a GPS constellation. As another example, in some embodiments, the location device 818 is a cellular device that receives location data from one or more localized cellular towers. Based on the position data, the computing device 800 may determine a local geographical area (e.g., town, city, state, etc.) of its position.

In some embodiments, the computing device 800 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 800 may be a computer, a workstation, a laptop, a server such as a cloud-based server, or any other suitable device. In some embodiments, the computing device 800 is a server that includes one or more processing units, such as one or more graphical processing units (GPUs), one or more central processing units (CPUs), and/or one or more processing cores. The computing device 800 may, in some embodiments, execute one or more virtual machines. In some embodiments, processing resources (e.g., capabilities) of the computing device 800 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
obtain user data from a first platform, the user data including:
i) item identifiers,
ii) first audience data including first audience interactions for a first period of time, and
iii) second audience data including second audience interactions for a second period of time, wherein the second period of time is before the first period of time;
generate synthetic data based on the first audience data and the second audience data, wherein the synthetic data is for a second platform, distinct from the first platform, and generating the synthetic data includes:
selecting a set of the first audience data and the second audience data,
selecting a predetermined number of the item identifiers, and
adding the predetermined number of the item identifiers to respective audience interactions of the set of the first audience data and the second audience data to form the synthetic data;
transmit the synthetic data to at least one computing device; and
receive, from the at least one computing device, engagement data responsive to the synthetic data.

2. The system of claim 1, wherein selecting the predetermined number of item identifiers includes:
receiving a user input requesting engagement;
determining, based on the user input, one or more parameters for selecting the predetermined number of item identifiers from the item identifiers;
randomizing the item identifiers based on the one or more parameters to form a randomized set of item identifiers; and
selecting the predetermined number of item identifiers from the randomized set of item identifiers.

3. The system of claim 1, wherein the instructions, when executed, further cause the processor to:
determine, based on the engagement data, a change in engagements in response to the synthetic data; and
in accordance with a determination that the change in the engagements in response to the synthetic data does not satisfy an engagement change threshold, adjust selection of the predetermined number of the item identifiers.

4. The system of claim 1, wherein the first platform is an in-store platform and the second platform is an online platform.

5. The system of claim 1, wherein the synthetic data includes control data and treated data, and wherein transmitting the synthetic data to the at least one computing device includes:
transmitting the control data to a first computing device; and
transmitting the treated data to a second computing device, distinct from the first computing device.

6. The system of claim 5, wherein the treated data includes simulated audience interactions that i) replace the respective audience interactions of the set of the first audience data and the second audience data and ii) anonymize the first audience data and the second audience data.

7. The system of claim 1, wherein the selecting the set of the first audience data and the second audience data includes:
generating qualified audience data, wherein generating the qualified audience data includes:
identifying duplicate audience interactions in the first audience interactions and the second audience interactions,
removing duplicate audience interactions between the first audience data and the second audience data, and
combining the first audience data and the second audience data to form the qualified audience data; and
selecting the set of the first audience data and the second audience data from the qualified audience data.

8. A computer-implemented method, comprising:
obtaining user data from a first platform, the user data including:
i) item identifiers,
ii) first audience data including first audience interactions for a first period of time, and
iii) second audience data including second audience interactions for a second period of time, wherein the second period of time is before the first period of time;
generating synthetic data based on the first audience data and the second audience data, wherein the synthetic data is for a second platform, distinct from the first platform, and generating the synthetic data includes:
selecting a set of the first audience data and the second audience data,
selecting a predetermined number of the item identifiers, and
adding the predetermined number of the item identifiers to respective audience interactions of the set of the first audience data and the second audience data to form the synthetic data;
transmitting the synthetic data to at least one computing device; and
receiving, from the at least one computing device, engagement data responsive to the synthetic data.

9. The computer-implemented method of claim 8, wherein selecting the predetermined number of item identifiers includes:
receiving a user input requesting engagement;
determining, based on the user input, one or more parameters for selecting the predetermined number of item identifiers from the item identifiers;
randomizing the item identifiers based on the one or more parameters to form a randomized set of item identifiers; and
selecting the predetermined number of item identifiers from the randomized set of item identifiers.

10. The computer-implemented method of claim 8, further comprising:
determining, based on the engagement data, a change in engagements in response to the synthetic data; and
in accordance with a determination that the change in the engagements in response to the synthetic data does not satisfy an engagement change threshold, adjusting selection of the predetermined number of the item identifiers.

11. The computer-implemented method of claim 8, wherein the first platform is an in-store platform and the second platform is an online platform.

12. The computer-implemented method of claim 8, wherein the synthetic data includes control data and treated data, and transmitting the synthetic data to the at least one computing device includes:
transmitting the control data to a first computing device; and
transmitting the treated data to a second computing device, distinct from the first computing device.

13. The computer-implemented method of claim 12, wherein the treated data includes simulated audience interactions that i) replace the respective audience interactions of the set of the first audience data and the second audience data and ii) anonymize the first audience data and the second audience data.

14. The computer-implemented method of claim 8, wherein the selecting the set of the first audience data and the second audience data includes:
generating qualified audience data, wherein generating the qualified audience data includes:
identifying duplicate audience interactions in the first audience interactions and the second audience interactions,
removing duplicate audience interactions between the first audience data and the second audience data, and
combining the first audience data and the second audience data to form the qualified audience data; and
selecting the set of the first audience data and the second audience data from the qualified audience data.

15. A non-transitory computer readable medium having instructions stored thereon, wherein the instructions, when executed by at least one processor, cause at least one device to perform operations comprising:
obtaining user data from a first platform, the user data including:
i) item identifiers,
ii) first audience data including first audience interactions for a first period of time, and
iii) second audience data including second audience interactions for a second period of time, wherein the second period of time is before the first period of time;
generating synthetic data based on the first audience data and the second audience data, wherein the synthetic data is for a second platform, distinct from the first platform, and generating the synthetic data includes:
selecting a set of the first audience data and the second audience data,
selecting a predetermined number of the item identifiers, and
adding the predetermined number of the item identifiers to respective audience interactions of the set of the first audience data and the second audience data to form the synthetic data;
transmitting the synthetic data to at least one computing device; and
receiving, from the at least one computing device, engagement data responsive to the synthetic data.

16. The non-transitory computer readable medium of claim 15, wherein selecting the predetermined number of item identifiers includes:
receiving a user input requesting engagement;
determining, based on the user input, one or more parameters for selecting the predetermined number of item identifiers from the item identifiers;
randomizing the item identifiers based on the one or more parameters to form a randomized set of item identifiers; and
selecting the predetermined number of item identifiers from the randomized set of item identifiers.

17. The non-transitory computer readable medium of claim 15, wherein the instructions, when executed by the at least one processor, further cause at least one device to perform operations comprising:
determining, based on the engagement data, a change in engagements in response to the synthetic data; and
in accordance with a determination that the change in the engagements in response to the synthetic data does not satisfy an engagement change threshold, adjusting selection of the predetermined number of the item identifiers.

18. The non-transitory computer readable medium of claim 15, wherein the first platform is an in-store platform and the second platform is an online platform.

19. The non-transitory computer readable medium of claim 15, wherein the synthetic data includes control data and treated data, and transmitting the synthetic data to the at least one computing device includes:
transmitting the control data to a first computing device; and
transmitting the treated data to a second computing device, distinct from the first computing device.

20. The non-transitory computer readable medium of claim 15, wherein the selecting the set of the first audience data and the second audience data includes:
generating qualified audience data, wherein generating the qualified audience data includes:
identifying duplicate audience interactions in the first audience interactions and the second audience interactions,
removing duplicate audience interactions between the first audience data and the second audience data, and
combining the first audience data and the second audience data to form the qualified audience data; and
selecting the set of the first audience data and the second audience data from the qualified audience data.
